(19) United States
(12) Patent Application Publication
(10) Pub. No.: US 2026/0222904 A1
(43) Pub. Date: Jul. 30, 2026

(54) SYSTEM AND METHOD FOR BUFFER CONTROL IN ULTRA-WIDEBAND COMMUNICATION

(71) Applicant: Qorvo US, Inc., Greensboro, NC (US)

(72) Inventors: Guillaume Vivier, Paris (FR); Eric Perraud, Plaisance du Touch (FR)

(21) Appl. No.: 19/146,467

(22) PCT Filed: Dec. 5, 2023
(86) PCT No.: PCT/US2023/082472

§ 371 Date: Jul. 8, 2025

Related U.S. Application Data
(60) Provisional application No. 63/481,327, filed on Jan. 24, 2023.
(60) Provisional application No. 63/512,210, filed on Jul. 6, 2023.

(51) Int. Cl. H04W 28/02; H04B 1/7163; H04L 5/00; H04W 72/0446; H04W 76/30

(52) U.S. Cl. CPC H04W 28/0278; H04B 1/7163; H04L 5/0053; H04W 72/0446; H04W 76/30

(57) ABSTRACT

A method for buffer control in UWB communication in a UWB device is provided. The method includes receiving an indication of a buffer status from another UWB device, and deriving a data transfer control message based on the indication of the buffer status in the other UWB device. The data transfer control message may include an updated slot allocation for the other UWB device. The method may also include sending the data transfer control message to the other UWB device.

### CROSS-REFERENCE TO RELATED APPLICATIONS

The present application claims the benefit of U.S. Provisional Application No. 63/481,327, filed Jan. 24, 2023, and U.S. Provisional Application No. 63/512,210, filed Jul. 6, 2023 which are incorporated herein by reference their entirety.

### FIELD OF THE DISCLOSURE

The present disclosure relates to ultra-wideband (UWB) communication between UWB devices, in particular, to a system and method for buffer control in UWB communication.

### BACKGROUND

Ultra-wideband (UWB) is a wireless communication technology that uses a wide bandwidth, typically about 500 MHz or larger, or has a 10 dB bandwidth greater than 20% of the center frequency. Impulse UWB (IR-UWB) is a specific case of UWB in which the signal is transmitted by very short pulses (in the order of nano seconds). It is particularly adapted for ranging or sensing application as the pulses are robust against multipath. Another advantage of IR-UWB is its ability to transmit data with low power consumption and low latency.

Ranging is a process of determining the distance between two devices using UWB technology. The FiRa (Fine Ranging) consortium was established to ensure interoperability between UWB enabled devices and enable various use cases. FiRa originally focused on ranging, but has introduced data transfer functionalities in recent years. Initially, data transfer was introduced as an add-on to ranging session: short packets were piggy-backed to ranging messages. However, buffer status for data transfer, e.g., reflecting the data queue for transmission and reception, is not often known for all UWB devices in communication, and this can cause buffer overflow, missing data, or data interference during data transfer. Thus, buffer control needs to be improved to obtain up-to-date information on buffer status from a UWB device.

### SUMMARY

Embodiments of the disclosure provide a method for buffer control in UWB communication in a UWB device. The method includes receiving an indication of a buffer status from another UWB device, and deriving a data transfer control message based on the indication of the buffer status in the other UWB device. The data transfer control message may include an updated slot allocation for the other UWB device. The method may also include sending the data transfer control message to the other UWB device.

In some embodiments, the indication of the buffer status comprises a buffer status report that is part of a link-layer control packet sent by the other UWB device.

In some embodiments, the method further includes sending a buffer status request to the other UWB device prior to receiving the buffer status report, the buffer status request comprising a command requesting for the buffer status in the other UWB device. The buffer status report includes a buffer status response by the UWB device replying to the buffer status request.

In some embodiments, the buffer status report comprises an indication of buffer status of a receiver buffer and a transmitter buffer in the other UWB device; and the data transfer control message comprises at least one of slot allocations for the receiver buffer and the transmitter buffer, or a request for connection termination.

In some embodiments, the buffer status report includes an indication of buffer status of at least a receiver buffer and a transmitter buffer for a normal connection, or a receiver buffer and a transmitter buffer for a secure connection; and the data transfer control message comprises slot allocations for the receiver buffer and the transmitter buffer for the normal connection, or the receiver buffer and the transmitter buffer for the secure connection.

In some embodiments, the link-layer control packet is a dedicated buffer control message and comprises a header field with all bits indicating a message type of the buffer status report, and a service data unit (SDU) indicating a content of the buffer status report.

In some embodiments, the link-layer control packet is an ACK/NACK control message and comprises a header field with a portion of the bits indicating a message type of the ACK/NACK control message and additional bits indicating the buffer status.

In some embodiments, the buffer status request is part of a link-layer control packet, and the link-layer control packet comprises a header field with all bits indicating a message type of the buffer status request, and a service data unit (SDU) indicating a content of the buffer status request.

In some embodiments, the data transfer control message includes a command for connection termination to the other UWB device.

In some embodiments, the indication of a usage of a buffer includes a set of configuration parameters transmitted by the other UWB device through a non-UWB channel, the set of configuration parameters reflecting the buffer status in the other UWB device.

In some embodiments, the non-UWB channel comprises a Bluetooth Low Energy channel.

In some embodiments, the method further includes, sending user data to the other UWB device based on the updated slot allocation.

In some embodiments, the indication of the buffer status is part of a message sent by the other UWB device.

In some embodiments, the indication of the buffer status is sent by an upper layer of the other UWB device to an upper layer of the UWB device.

Embodiments of the present disclosure provide a UWB device. The UWB device includes a transceiver operable to perform a UWB communication, a memory for storing program instructions and a buffer status of another UWB device, and a processor coupled to the transceiver and to the memory. The processor is operable to execute the program instructions, which, when executed by the processor, cause the UWB device to perform the following to facilitate slot allocation to support data communication from/to the other UWB device. The operations include receiving an indication of a buffer status from the other UWB device and deriving a data transfer control message based on the indication of the buffer status in the other UWB device. The data transfer control message includes an updated slot allocation for the other UWB device. The operations also include sending the data transfer control message to the other UWB device.

In some embodiments, the indication of the buffer status includes a buffer status report that is part of a link-layer control packet sent by the other UWB device.

In some embodiments, the UWB device further includes sending a buffer status request to the other UWB device prior to receiving the buffer status report, the buffer status request including a command requesting for the buffer status in the other UWB device. The buffer status report includes a buffer status response by the UWB device replying to the buffer status request.

In some embodiments, the buffer status report comprises an indication of buffer status of a receiver buffer and a transmitter buffer in the other UWB device, and the data transfer control message comprises a command for slot allocations for the receiver buffer and the transmitter buffer.

In some embodiments, the link-layer control packet comprises a header field indicating a message type of the buffer status report, and a service data unit (SDU) indicating a content of the buffer status report.

In some embodiments, the buffer status request is part of a link-layer control packet, and the link-layer control packet comprises a header field indicating a message type of the buffer status request, and a service data unit (SDU) indicating a content of the buffer status request.

Embodiments of the present disclosure provide a method for buffer control in UWB communication in a UWB device. The method includes configuring a buffer status, transmitting an indication of the buffer status to another UWB device, receiving a data transfer control message from the other UWB device, the data transfer control message comprising an updated slot allocation for the buffer based on the indication of the buffer status, and transmitting data in slots allocated according to the updated slot allocation.

In some embodiments, the indication of the buffer status comprises at least one of: a buffer status report that is part of a link-layer control packet, or a set of configuration parameters transmitted through a non-UWB channel, the set of configuration parameters reflecting the buffer status in the other UWB device.

In some embodiments, the method includes transmitting the indication of the buffer status without receiving a buffer status request that includes a command requesting for the buffer status.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description, serve to explain the principles of the disclosure.

FIG. 1A illustrates an exemplary system of a controller ultra-wideband (UWB) device and a controlee UWB device for implementing buffer control, according to some aspects of the present disclosure.

FIG. 1B illustrates an exemplary signaling diagram in which a controller UWB device and a plurality of controlee UWB devices implement buffer control, according to some aspects of the present disclosure.

FIG. 1C illustrates an exemplary architecture of a UWB device for implementing buffer control, according to some aspects of the present disclosure.

FIG. 1D illustrates architectures of two UWB devices, in communication, for implementing buffer control, according to some aspects of the present disclosure.

FIG. 1E illustrates an exemplary architecture of a UWB device, having a plurality of buffers, for implementing buffer control, according to some aspects of the present disclosure.

FIG. 2A illustrates frames structures used in UWB communication, according to some aspects of the present disclosure.

FIG. 2B illustrates a packet used in UWB communication.

FIG. 2C illustrates messages fields of a packet used in UWB communication.

FIGS. 3A-3E each illustrates an exemplary packet and message fields of the packet for implementing buffer control in UWB communication, according to some aspects of the present disclosure.

FIG. 4 illustrates another exemplary signaling diagram in which buffer control is implemented using a non-UWB channel, or out-of-band (OOB) technology, according to some aspects of the present disclosure.

FIGS. 5A and 5B each illustrates a method for implementing buffer control in UWB communication, according to some aspects of the present disclosure.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein. Additionally, like reference numerals denote like features throughout specification and drawings.

It should be appreciated that the blocks in each signaling diagram or flowchart and combinations of the signaling diagrams or flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each signaling diagram or flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction for performing the functions described in connection with a block(s) in each signaling diagram or flowchart. Since the computer program instructions may be equipped in a computer or other programmable data processing devices, instructions that generate a process executed by a computer as a series of operational steps are performed by the computer or other programmable data processing devices and operate the computer or other programmable data processing devices may provide steps for executing the functions described in connection with a block(s) in each signaling diagram or flowchart.

Each block may represent a module, segment, or part of a code including one or more executable instructions for executing a specified logical function(s). Further, it should also be noted that in some replacement execution examples, the functions mentioned in the blocks may occur in different orders. For example, two blocks that are consecutively shown may be performed substantially simultaneously or in a reverse order depending on corresponding functions.

Hereinafter, embodiments are described in detail with reference to the accompanying drawings. Further, although a communication system using ultra-wideband (UWB) is described in connection with embodiments, as an example, the embodiments may also apply to other communication systems with similar technical background or features. For example, a communication system using Bluetooth or ZigBee may be included therein. Further, embodiments may be modified in such a range as not to significantly depart from the scope of the present disclosure under the determination by one of ordinary skill in the art and such modifications may be applicable to other communication systems.

UWB may refer to a short-range high-rate wireless communication technology using a wide frequency band of several GHz or more, low spectral density, and short pulse width (e.g., 1 nsec to 4 nsec) in a baseband state. UWB may mean a band itself to which UWB communication is applied. UWB may enable secure and accurate ranging between devices. Thus, UWB enables relative position estimation based on the distance between two devices or accurate position estimation of a device based on the distance from fixed devices (whose positions are known, also referred to as anchor devices). The present disclosure assumes that the user is carrying a device capable of communicating through UWB (referred to as “UWB-enabled device” or simply as “UWB device”). More generally, the present disclosure assumes communication between two UWB devices.

In data transfer, a controller UWB device (or simply controller) acts as the central scheduler to decide how time slots (or interchangeably, slots, in this disclosure) can be allocated for data transfer to a controlee UWB device (or simply controlee) in both directions, downlink (DL, from controller to controlee) and Uplink (UL, from controlee to controller). A controlee UWB device sends and receives data in frames that are transmitted in the slots allocated by the controller UWB device. While controller has knowledge of its own data to be transferred to controlee (and therefore it can allocate slots accordingly), it has no knowledge of the data queue in the controlee. For example, the controller has no information if the controlee needs more slots for data transfer or on the contrary has completed its data transfer. Currently, there is no means to inform the controller about the data queues in the controlee(s).

To solve this problem, the present disclosure provides a new signaling scheme to support buffer status report from a controlee UWB device and early termination of connection between UWB devices. Such signaling will enhance the current signaling scheme to make the data transfer more efficient. The proposal covers signaling made during the establishment of the connection, as well as more dynamic signaling during the lifetime of the connection, allowing more immediate connection release when appropriate (when nothing more has to be transmitted).

Embodiments of the present disclosure provide a feedback mechanism implemented between a controller UWB device and a controlee UWB device to help the controller UWB device acknowledge the buffer statuses in the controlee UWB device, and thus allocate slots for data transmission more accurately. In the present disclosure, a UWB device (e.g., a controlee UWB device) may send a buffer status report to another UWB device (e.g., a controller UWB device) to report the buffer status. The UWB device may send the buffer status report voluntarily or in response to a buffer status request sent by the other UWB device. The other UWB device may accordingly transmit a data transfer control message to maintain or adjust the slot allocation. For example, the buffer status report may include information on the occupancy of the buffers for receiving and transmitting data such that the other UWB device may decide changing or maintaining the slot allocation for the UWB device, and/or terminating the connection. The controller UWB device and the controlee UWB device may thus transmit data in the slots allocated based on the buffer status of the controlee UWB device.

The buffer status report and the buffer status request may each be in a link-layer control packet, with the header indicating the message type (e.g., a buffer status message). In some embodiments, the header may also include information on the buffer status (e.g., usage and/or occupancies). In some embodiments, the buffer status is included in the service data unit (SDU) of the packet. In some embodiments, the UWB device includes more than one buffer for receiving data (e.g., for normal (or generic) communication and secure communication) and the more than one buffer for transmitting data (e.g., for normal communication and secure communication). The SDU may include a bitmap indicating the usage of all buffers. The link-layer control packet can be generated and processed at the link layer level by the UWB devices, without having to be processed by upper layers (e.g., at an application level).

In some embodiments, before data transmission, UWB device may exchange buffer status report as part of the parameters to each, to configure the UWB device and decide slot allocation by one (e.g., the controller) of the UWB devices. In some embodiments, this exchange is performed in an out-of-band (OOB) channel, such as a Bluetooth channel. The proposed system and method can facilitate more efficient and more accurate slot allocation in UWB communication, following dynamically the actual needs of the controlee UWB device. Accordingly, more stringent application requirements can be met, with lower risk of buffer overflow. This may lead to shorter communications, saving time, battery life, and cost. Also, the direct communication between UWB devices at link layer level can further shorten the communication time and cost. In some embodiments, the method and system can be implemented between a user mobile device (e.g., a controlee) and a UWB device (e.g., a controller) installed at a point of sales (POS). The user mobile device may be the controlee UWB device, and the UWB device installed at the POS may be the controller UWB device. The disclosed methods and system can optimize the data transfer between the controller and controlee UWB devices, and may potentially reduce payment time.

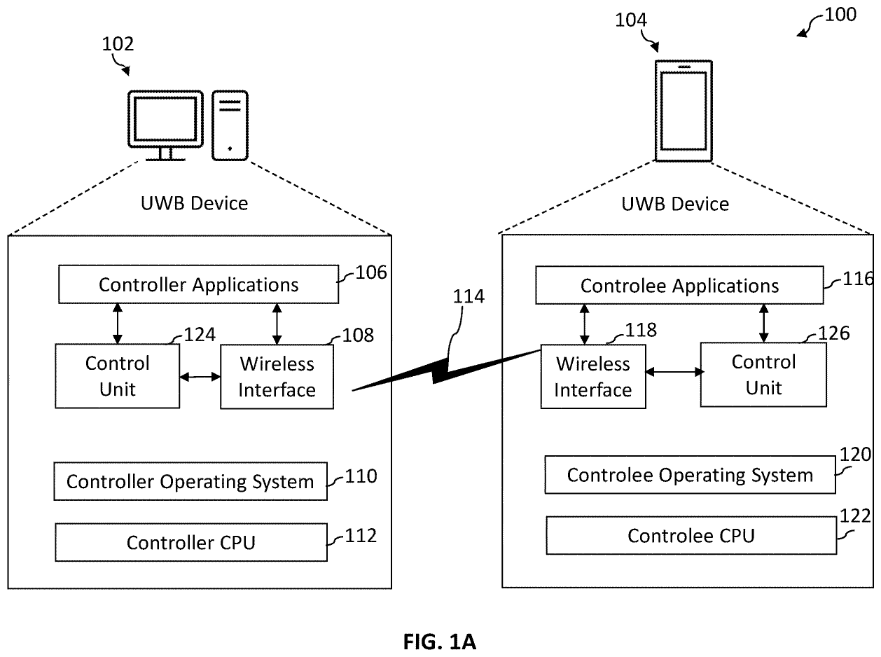

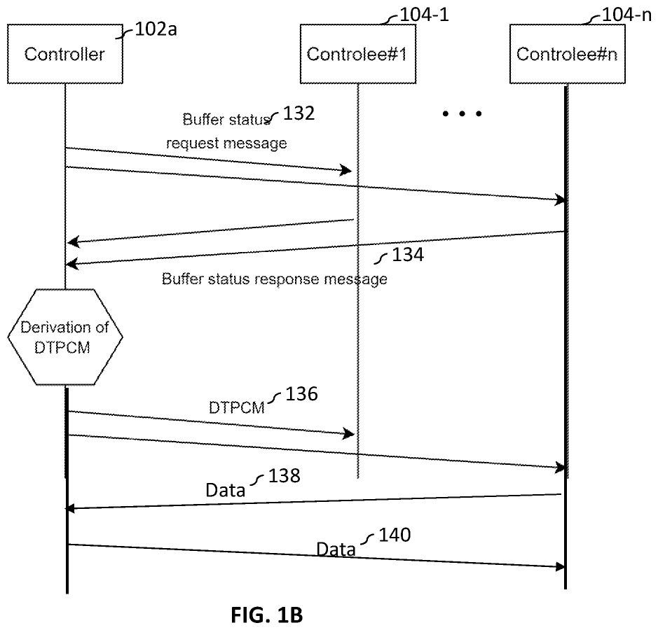

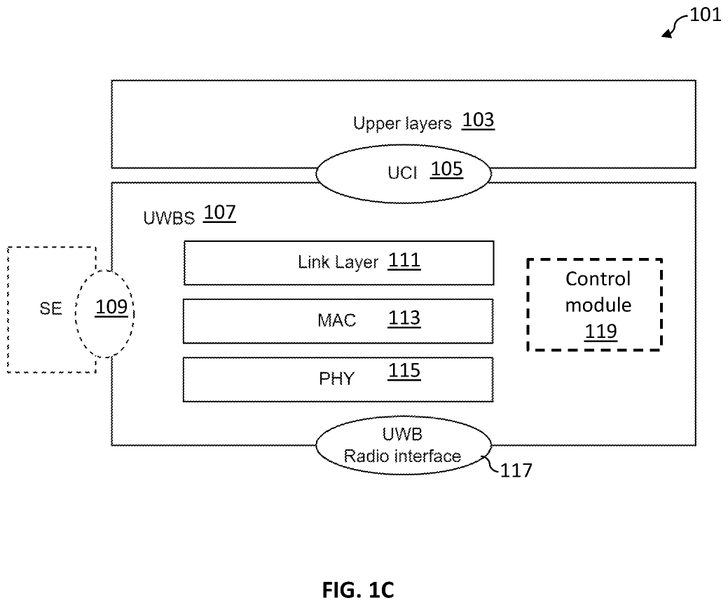

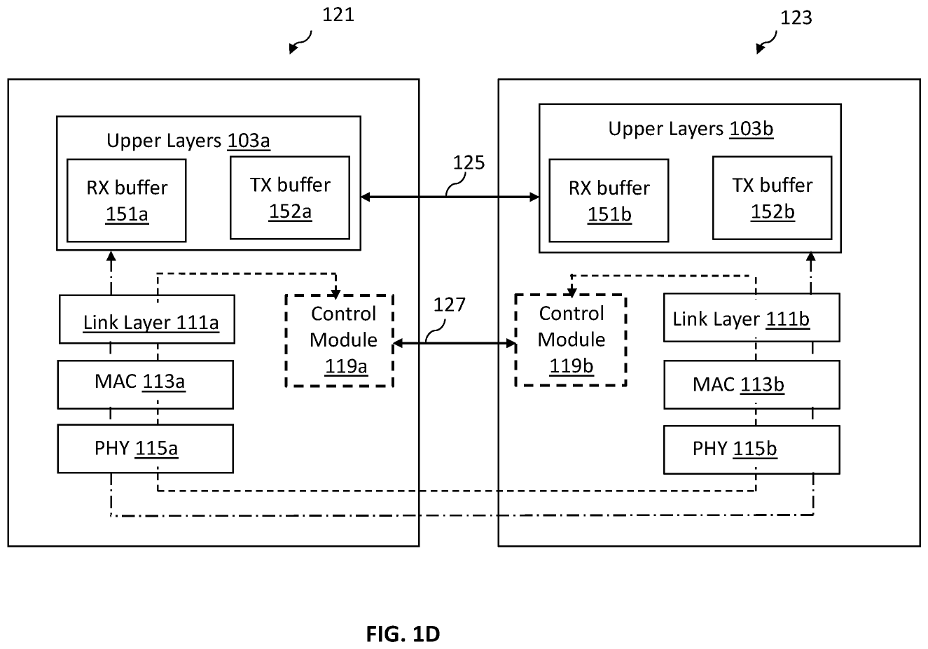

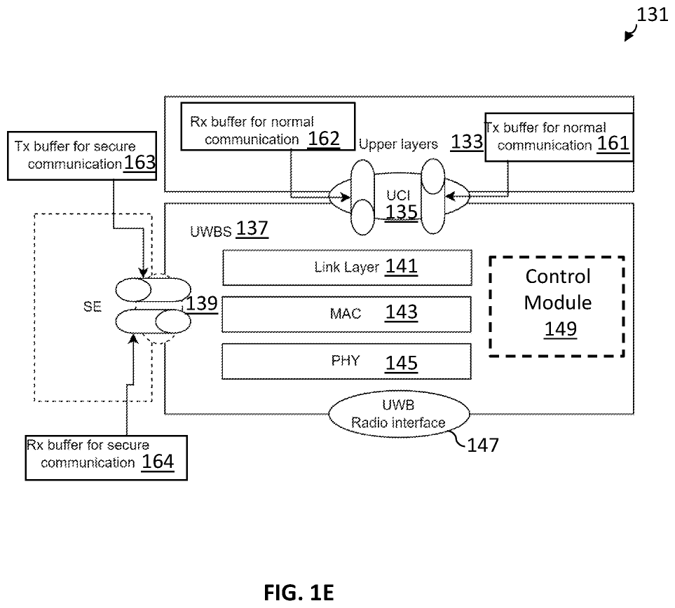

FIG. 1A depicts an exemplary system 100 for implementing the buffer control in UWB communication, according to one embodiment of the present disclosure. The system 100 may include a UWB device 102 that is in wireless communication with another UWB device 104, as symbolically illustrated by a wireless link 114. UWB device 102 may be the controller UWB device (or simply controller), and UWB device 104 may be the controlee UWB device (or simply controlee) in the wireless communication. UWB device 102 may be an on-board computer or a mobile device. In some embodiments, UWB device 104 is a mobile device. For example, UWB device 102 may be a device for contactless payment installed at a POS, and UWB device 104 may be a user mobile device. It is noted here that the terms “mobile device,” “mobile handset,” “wireless handset,” and “User Equipment (UE)” may be used interchangeably hereinbelow to refer to a wireless communication device that is capable of voice and/or data communication. Some examples of such mobile handsets include smartphones, tablets, and wearable devices. It is observed here that, UWB device 102 may not have to be a separate computing unit (in hardware or software form) dedicated to carry out the buffer control functionality. In one embodiment, the functionality of the UWB device 102 may be implemented in an already-existing physical computing/data processing unit or (nonphysical) server software in a cloud. The wireless link 114 may include a UWB communication interface. The wireless link 114 may also support other types of wireless connections, such as a Bluetooth communication interface, a Wi-Fi communication interface, a cellular network connection (e.g., 4G, 5G) interface, a near field communication (NFC) interface, a ZigBee communication interface, or a combination thereof.

A control unit 124/126 is one of the mobile applications respectively installed in the UWB device 102/104. In addition to control unit 124/126, UWB devices 102 and 104 may each also have one or more mobile applications (e.g., controller applications 106/controlee applications 116) reside therein. These mobile applications are software modules that may have been pre-packaged with the respective UWB device 102/104 or may have been downloaded by a user into the memory (not shown) of the respective UWB device 102/104. For example, UWB device 102 may also store in its memory (not shown) other controller-specific applications such as, for example, an application that facilitates Ethernet-based communication, an application that interacts with cloud, and the like. In some embodiments, control units 124 and 126 perform the buffer control for UWB communication. For example, control units 124 and 126 may generate and process control packets that are transmitted between UWB devices 102 and 104 for buffer control functions. Detailed description is included below. The mobile applications as well as the control units (e.g., 124 and 126) may be executed by the processors respectively under the control of the mobile operating systems (e.g., controller operating system 110 and controlee operating system 120). UWB device 102 may include a relatively high-powered controller Central Processing Unit (CPU) 112 executing controller operating system 110. UWB device 102 may further include a wireless interface 108 to facilitate wireless communication with UWB device 104 via the wireless link 114. The applications (e.g., 106 and 124) may utilize the wireless interface 108 as needed.

Because of the battery-powered nature of mobile devices, in some embodiments, the processor of UWB device 104 (e.g., a controlee CPU 122) may be designed to conserve battery power, such as a relatively low-powered CPU. UWB device 104 may wirelessly communicate with the UWB device 102 via its own wireless interface 118. The wireless interfaces units 108 and 118 may wirelessly transfer data or information between the UWB device 102 and the UWB device 104 using the wireless link 114 as shown.

Thus, in operation, a device-generated signal may be wirelessly sent from one UWB device (e.g., UWB device 102) to the other UWB device (e.g., UWB device 104) for further processing by the CPU of the other UWB device (e.g., CPU 122), and vice versa. Specifically, the signal may be sent by the wireless interface of one UWB device (e.g., wireless interface 108 of UWB device 102) over wireless link 114 to the wireless interface of the other UWB device (e.g., wireless interface 118 of UWB device 104). The device-generated signal (e.g., a voluntarily-sent signal or a response to a request) from a UWB device (e.g., UWB device 102 or 104) can be provided in the device-recognized wireless format by a wireless interface (e.g., wireless interface 108) and eventually delivered to the other wireless interface (e.g., wireless interface 118) through wireless link 114. The resulting wireless “link” between the wireless interfaces 108 and 118 is symbolically illustrated by the bi-directional arrow. As discussed above, wireless link 114 may represent a hybrid wireless communication approach that combines UWB communication and one or more wireless communications other than UWB (e.g., Bluetooth, Wi-Fi, and/or cellular data). As to be discussed in further detail below, control units 124 and 126 may collect buffer-related information and generate link-layer (LL) control messages/packets that contain a request for buffer status of the other UWB device, or an indication of its own buffer status. The wireless interface (e.g., wireless interface 108 or 118) may transmit or receive a physical-layer packet that includes the LL control message in the form of the device-generated signal. The CPU (e.g., CPU 112 or 122) may generate a LL control message related to buffer control (e.g., a request for buffer status and/or a voluntary report of buffer status) and process a received LL control message (e.g., a request for buffer status and/or a response of buffer status to the request). By directly processing the buffer control on a link layer level, the UWB devices (e.g., UWB devices 102 and 104) may not need to process packets from upper layers (e.g., application layer or software). The processing of packets can be more efficient, reducing the transmission time and cost.

FIG. 1B shows an illustrative embodiment of a controller UWB device in communication with one or more controlee UWB devices, according to some embodiments of the present disclosure. Controller 102a (e.g., a controller UWB device) may be an example of UWB device 102. Controlee #1 104-1, . . . , and controlee #n 104-n may represent n controlee UWB devices each being an example of UWB device 104 (n is a positive integer). In some embodiments, after the UWB connection between controller 102a and a controlee (e.g., controlee #1 104-1, . . . , and/or controlee #n 104-n) is established, controller 102a may transmit a buffer status request message 132 to each controlee (e.g., controlee #1 104-1, . . . , and/or controlee #n 104-n). As will be described later in detail, buffer status request message 132 includes a LL control message that inquires the buffer status (e.g., usage and/or occupancies) of each of controlee #1, . . . , and controlee #n.

Receiving buffer status request message 132, a controlee (e.g., controlee #1 104-1, . . . , and/or controlee #n 104-n) may transmit a buffer status response message 134 (e.g., a buffer status report message) to controller 102a. The buffer status response message 134 may include a LL control message that indicates the usage of one or more buffers in the respective controlee. For example, the LL control message may include the usage of one or more buffers for receiving data and one or more buffers for transmitting data. Controller 102a, after receiving buffer status response message 134, may determine the slots to be allocated to each of the controlees (e.g., controlee #1 104-1, . . . , and controlee #n 104-n), and generate a data transfer control message 136 (e.g., data transfer phase control message or DTPCM) based on the buffer status(s) provided in the buffer status response message 134. The data transfer control message may include an updated the slot allocation (e.g., as determined by controller 102a) for the controlee (e.g., controlee #1 104-1, . . . , and/or controlee #n 104-n). For example, the updated slot allocation may include slots allocated for receiving data and/or transmitting data by the controlee based on the buffer status provided by the controlee. In some embodiments, the slots allocated for the controlee to receive data is determined at least based on the buffer usage/occupancy of the controlee's receiver buffer, and the slots allocated for the controlee to receive data is determined at least based on the buffer usage/occupancy of the controlee's transmitter buffer. The controlee may thus transmit data 138 in the allocated (e.g., updated) slots for transmitting data, and/or controller 102a may transmitting data 140 to the controlee in the allocated (e.g., updated) slots for receiving data. In some embodiments, the data transfer control message may additionally or alternatively include a command to terminate the connection (if the controlee reports that no data is to be transmitted) early. The controlee, receiving data transfer control message 136, may terminate the connection.

In some embodiments, a controlee (e.g., controlee #1 104-1, . . . , and/or controlee #n 104-n) sends a buffer status report message to controller 102a without any buffer status request message 132. For example, after the UWB connection between controller 102a and the controlee (e.g., controlee #1 104-1, . . . , and/or controlee #n 104-n) is established, the controlee may voluntarily send a buffer status report message to controller 102a. The buffer status report message may include a LL control message that indicates the usage and occupancies of one or more buffers for receiving data and one or more buffers for transmitting data in the respective controlee. Controller 102a, after receiving buffer status report message, may generate a data transfer control message (e.g., data transfer phase control message or DTPCM) 136 based on the buffer status(s) provided in the buffer status report message for slot allocation for the controlee and/or early termination of the connection, as described above.

FIG. 1C illustrates a diagram of the architecture (e.g., layered view) of a UWB device 101, according to some embodiments of the present disclosure. UWB device 101 may be an example of UWB devices 102 and 104. As shown in FIG. 1C, UWB device 101 may include one or more upper layers 103, a UWB control interface (UCI) 105, a secure element (SE) interface 109, a link layer 111, a medium access control (MAC) layer 113, a physical (PHY) layer 115, a UWB radio interface 117, and a control module 119. In some embodiments, UCI 105, link layer 111, MAC layer 113, PHY layer 115, SE interface 109, and UWB radio interface 117 may be referred to as a UWB system (UWBS) 107.

PHY layer 115 is configured to transport data (e.g., packets such as control packets and data packets) using its interfaces, such as UWB radio interface 117. PHY layer 115 provides electrical, mechanical, and/or procedural interfaces to the transmission medium. MAC layer 113 is configured to control the hardware responsible for interaction with the wired, optical, and/or wireless transmission medium. Link layer 111 is configured to provide method and communication protocols confined to the link that UWB device 101 is connected to. For example, link layer 111 generates packets by framing data bits such as source and destination addresses, information to detect and control transmission errors, message types, and indication of buffer status to the data stream. SE interface 109 allows UWBS 107 to directly communicate with an SE through link layer 111, MAC layer 113, PHY layer 115, and SE interface 109. Upper layers 103 may include layers above link layer 111, such as network layer, transport layer, session layer, presentation layer, and application layer, each having its respective functionality for UWB system communication. Upper layers 103 communicate with UWBS 107 through UCI 105. UCI 105 may allow the host (e.g., UWB device 101) to configure and control UWBS 107 and gather information form UWBS 107, and may allow the UWBS 107 to receive configuration parameters from upper layers 103.

Control module 119 may control the functions of link layer 111. For example, control module 119 may control the generating, receiving, and analyzing the link layer control messages. Control module 119 may be a dedicated entity for the control of link layer 111, or may be part of a more general control entity of UWB device 101 for controlling various other layers. For example, control module 119 may perform part or the entirely functions of control unit 124 (and/or control unit 126). For example, control module 119 may include any suitable hardware and/software that can control link layer 111. Control module 119 may allow the packets transmitted between two UWB devices to be parsed and executed at the link layer level, without having to be transmitted and parsed at a higher layer level. In some embodiments, control module 119 is communicatively connected to upper layers 103 to gather/receive configuration inputs. On the transmitter side, control module 119 may use the gathered/received information to construct the link-layer (LL) header and adding the LL header to the LL packet data unit (PDU). On the receiver side, control module 119 may use the gathered/received information to parse the received LL headers and determine the operations to be done, accordingly.

UCI 105 may configure data to be transmitted based on information collected from upper layers 103. The data to be transmitted may further be used to determine buffer status. In some embodiments, UWB device 101 may include commands in UCI 105 to provide information about the data to be transmitted, or more generally a command to configure the data transfer. For example, the command may include UCI 105 gathering information on size of the complete data messages to be transmitted, type of connection for transmission, and/or possible proposal of slot allocation. UCI 105 may transmit data and/or parameters to UWBS 107 for control module 119 to construct frames for various layers.

FIG. 1D illustrates a layered view of two UWB devices in communication, according to some embodiments of the present disclosure. Specifically, FIG. 1D illustrates a data panel showing the exchange of packets and a control panel showing the exchange of control packets between a UWB device 121 and a UWB device 123. UWB device 121 may be an example of one of UWB devices 102 and 104, and UWB device 123 may be an example of the other one of UWB devices 102 and 104. UWB devices 121 and 123 respectively includes a control module (e.g., control module 119a and 119b), which is an example of control module 119. UWB device 121 may include a link layer 111a, a MAC layer 113a, a PHY layer 115a, and upper layers 103a; and UWB device 123 may include a link layer 111b, a MAC layer 113b, a PHY layer 115b, and upper layers 103b. The link layers (e.g., 111a and 111b), the MAC layers (113a and 113b), the PHY layers (115a and 115b), and the upper layers (103a and 103b) may be examples of link layer 111, MAC layer 113, PHY layer 115, and upper layers 103, respectively. The dashed lines represent the exchange of control packets, and the dash-dotted lines represent the exchange of packets. In some embodiments, upper layers 103a includes or is coupled to receiver (“RX”) buffer 151a and a transmitter (“TX”) buffer 152a; and upper layers 103b includes or is coupled to RX buffer 151b and a TX buffer 152b. UWB device 121 or 123 may collect usage/occupancy information of the respective RX and TX buffers (e.g., 151a and 152a, or 151b and 152b), and may transmit the information to lower layers, e.g., the respective link layer, MAC layer, and PHY layer, for constructing of control messages.

As shown in FIG. 1D, when UWB devices 121 and 123 are in communication, packets may be transmitted through the link layer (e.g., link layer 111a or 111b), the MAC layer (e.g., MAC layer 113a or 113b), the PHY layer (e.g., PHY layer 115a or 115b), and to the upper layers (e.g., upper layers 103a or 103b) of each UWB device (e.g., UWB device 121 or 123). The exchange of data packets is represented by arrows 125, between the upper layers of UWB devices 121 and 123. Control packets may be transmitted through the link layer, the MAC layer, and the PHY layer of each UWB device. In some embodiments, the control packets are processed by the respective control module (e.g., control module 119a or 119b), and is not further transmitted to the upper layers of the respective UWB device. For example, the control module (e.g., control module 119a) is configured to generate a LL control message/packet that contains indication of buffer status (e.g., usage and/or occupancies) of the respective UWB device (e.g., RX and TX buffers 151a and 152a of UWB device 121), and can also receive, parse, and analyze a LL control message/packet from another UWB device (e.g., UWB device 123) that includes an indication of buffer status (e.g., RX and TX buffers 151b and 152b). In various embodiments, the buffer status of one or both of the RX and TX buffers is transmitted in the LL control message. The control module (e.g., control module 119a) may also determine the operations based on the received indication of buffer status, such as adjusting allocation of slots for the UWB device (e.g., UWB device 121), terminating connection, etc. The exchange of control packets is represented by arrows 127, between the control modules of UWB devices 121 and 123.

FIG. 1E illustrate a scenario that a UWB device 131 having more than one buffer for receiving data and more than one buffer for transmitting data, according to some embodiments of the present disclosure. UWB device 131 may be an example of UWB device 102 or 104. In a layered view, UWB device 131 may include upper layers 133, UCI 135, link layer 141, MAC layer 143, PHY layer 145, UWB radio interface 147, SE interface 139, and control module 149. Link layer 141, MAC layer 143, PHY layer 145, SE interface 139, UCI 135, control module 149, and UWB radio interface 147 may be referred to as UWBS 137. These parts of UWB device 131 may be similar to their counterparts illustrated in FIG. 1C, and the detailed description is not repeated. In some embodiments, as shown in FIG. 1E, UWB device 131 include more than one buffer for receiving data, and more than one buffer for transmitting data. For example, UWB device 131 may include a TX buffer 161 for transmitting data for normal communication (e.g., from/to upper layers 133 through the UCI) and a RX buffer 162 for receiving data for normal communication. UWB device 131 may also include a TX buffer 163 for transmitting data for secure communication (e.g., from/to the secure element through SE interface 139) and a RX buffer 164 for receiving data for secure communication. In other words, UWB device 131 may include a plurality of buffers to handle multiple quality of services. In some embodiments, a single LL control message can be used to indicate the status of one or more buffers (e.g., each buffer), as will be described below in detail.

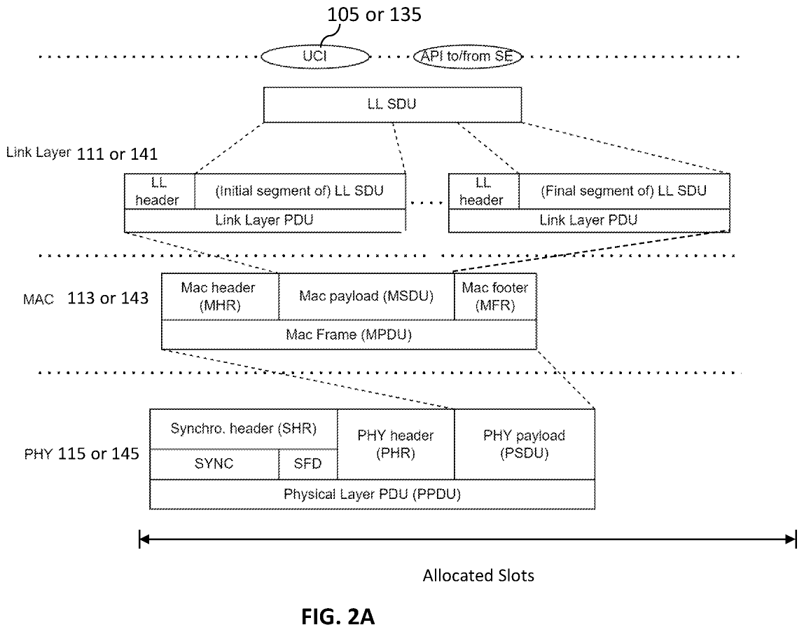

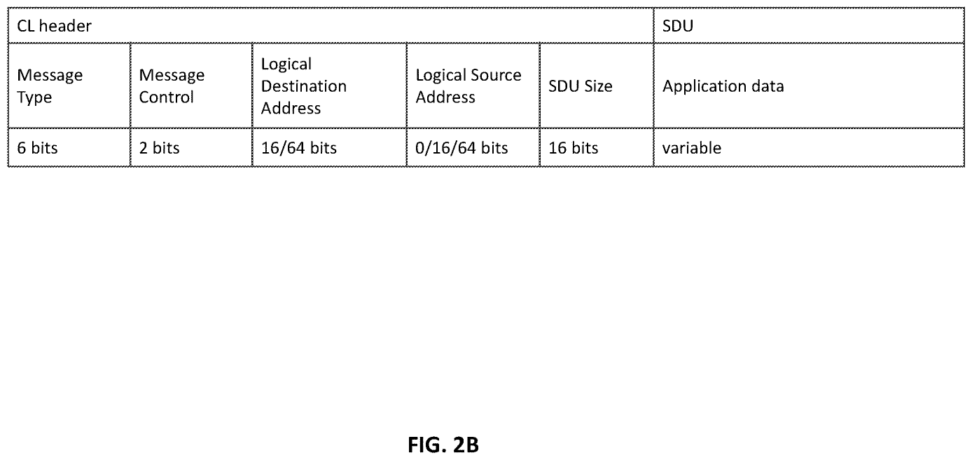

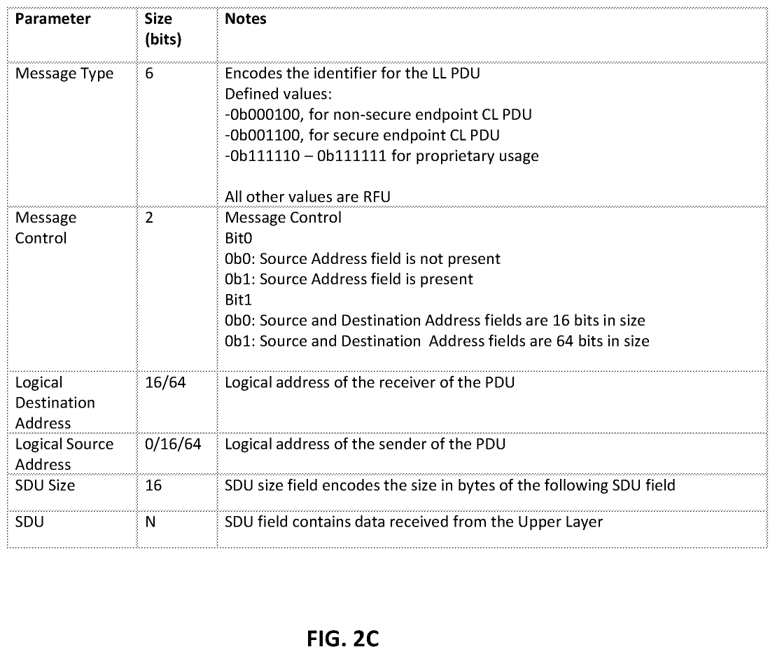

FIG. 2A illustrates a process to form a packet for transmission through different layers of a UWB device. A packet, including various data such as user data, may be transmitted from upper layers (e.g., upper layers 103 and/or 133) and/or secure element to the UWB radio interface (e.g., UWB radio interface 117 and/or 147). As shown in FIG. 2A, on the transmitter side, a data payload (e.g., LL SDU) may be provided to the UWBS (e.g., UWBS 107 and/or 137) through the UCI (e.g., UCI 105 and/or 135) to the link layer (e.g., link layer 111 and/or 141). The payload can be segmented and a LL header may be appended to the segment. The LL header and the segment may from the LL packet data unit (PDU). The LL PDU may then be then transmitted to the MAC layer (e.g., MAC layer 113 and/or 143). The LL PDU may then be embedded into a MAC payload (or MAC SDU or MSDU). The MSDU may be appended to a MAC header and a MAC footer, forming a MAC frame or MAC protocol data unit (MPDU). The MPDU may be transmitted to the PHY layer (e.g., PHY layer 115 and/or 145). The MPDU may then be embedded into a PHY payload (or physical layer convergence procedure SDU or PSDU). The PSDU may be appended to a PHY header and a synchronization header (or SHR), forming a physical layer protocol data unit or (PPDU). The PPDU may then be transmitted to another UWB device (through the UWB radio interface or the SE interface).

On the receiver side, a packet from another UWB device may be received at the PHY layer (e.g., PHY layer 115 and/or 145), and may be parsed at the PHY layer level, the MAC layer level (e.g., MAC layer 113 and/or 143), and the link layer level (e.g., link layer 111 and/or 141). For example, a link layer PDU may be received at the link layer and may be processed.

A controlee UWB device may transmit data in its buffer(s) in PPDU to a controller UWB device. In the embodiments of the present disclosure, when the number of slots allocated to a controlee UWB device for transmitting data is updated (e.g., in a data transfer control message), the controlee UWB device may transmit data (e.g., data 138) in the allocated/updated slots to the controller UWB device. When the number of slots allocated to the controlee UWB device for receiving data is updated (e.g., in the data transfer control message), the controller UWB device may transmit data (e.g., data 140) in the allocated/updated slots to the controlee UWB device.

FIG. 2B illustrates an existing design of the LL packet including a LL header for connection less (CL) mode. The LL header generally contains at least the following information: the type of the LL packet, a sequence number, a segmentation (or chaining) indicator, the size of the actual packet payload, and an indicator of the logical connection the packet belongs to. FIG. 2C illustrates the existing definition of message fields in the LL packet shown in FIG. 2B. As shown in FIGS. 2B and 2C, an existing LL packet, e.g., LL control message, has no field for indication of buffer status.

Embodiments of the present disclosure introduce a novel LL control message that contains indication of buffer status. The LL control message may be referred to as a buffer status message, which inquires or provides buffer status in a controlee UWB device (e.g., UWB device 104). The buffer status message may include a buffer status request message, which is transmitted by a controller UWB device (e.g., UWB device 102) and received by a controlee UWB device (e.g., UWB device 104) for the controller UWB device to request the buffer status in the controlee UWB device. The buffer status message may also include a buffer status report message, which is transmitted by the controlee UWB device to the controller UWB device reporting the buffer status in the controlee UWB device. The buffer status report message may be sent voluntarily (or proactively) by the controlee UWB device or may be a response to the buffer status request message. Specifically, when the buffer status report message is sent as a response, the buffer status report message may also be referred to as a buffer status response message. In some embodiments, the controlee UWB device can also send a buffer status request message to the controller UWB device to request the controller UWB device to provide its buffer status (e.g., usage and/or occupancies).

The disclosed LL control message, e.g., a buffer status message, can be distinguished from other LL control messages by its LL header and/or content. For example, a buffer status request message may include indicate it is a buffer status message or buffer status request message in its LL header, and may not have a content. In some embodiments, the content of a buffer status request message includes indication of the current slot allocation for the controlee UWB device, the size of data to be transmitted to the controlee UWB device, etc. A buffer status report message and/or a buffer status response message may indicate information such as the current buffer status(s) of the controlee UWB device, whether the current slot allocation is sufficient, whether the connection to the controller UWB device should be terminated, etc.

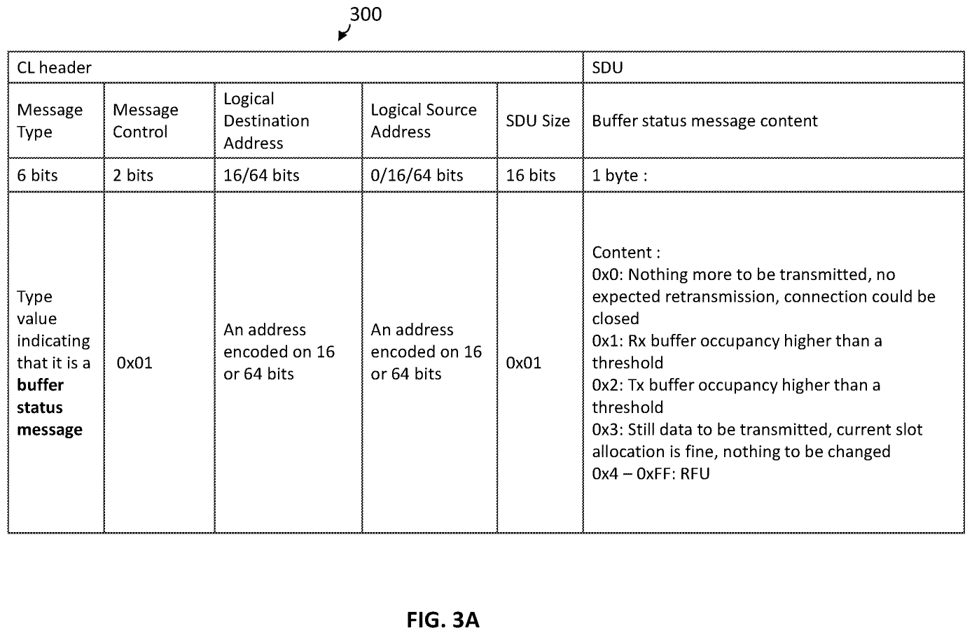

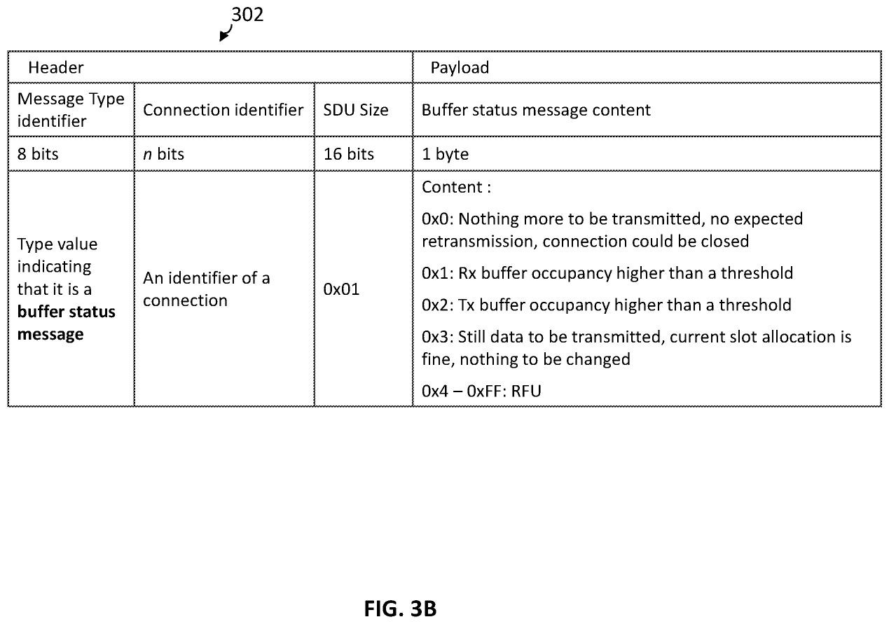

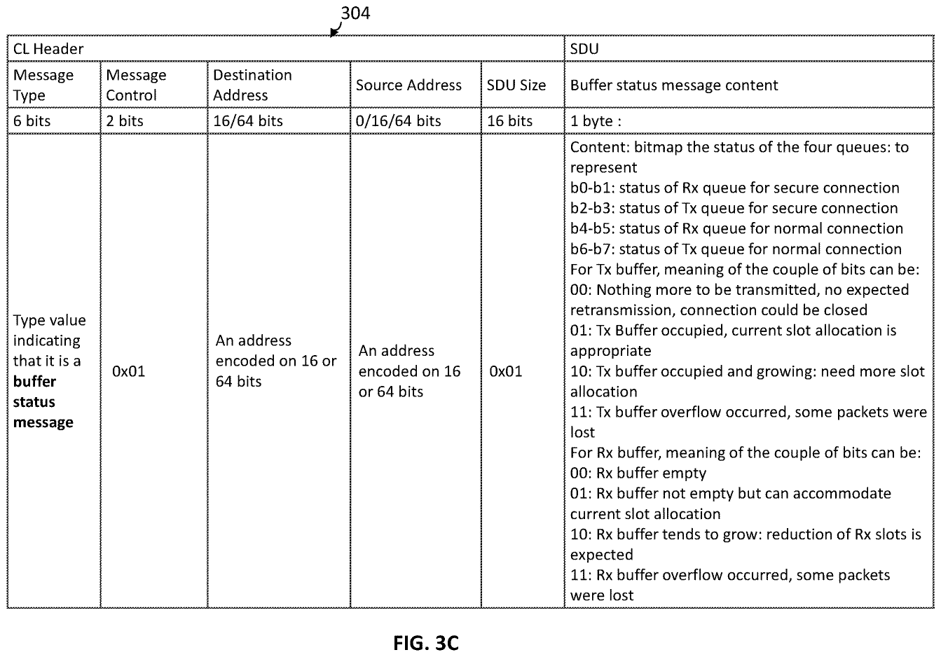

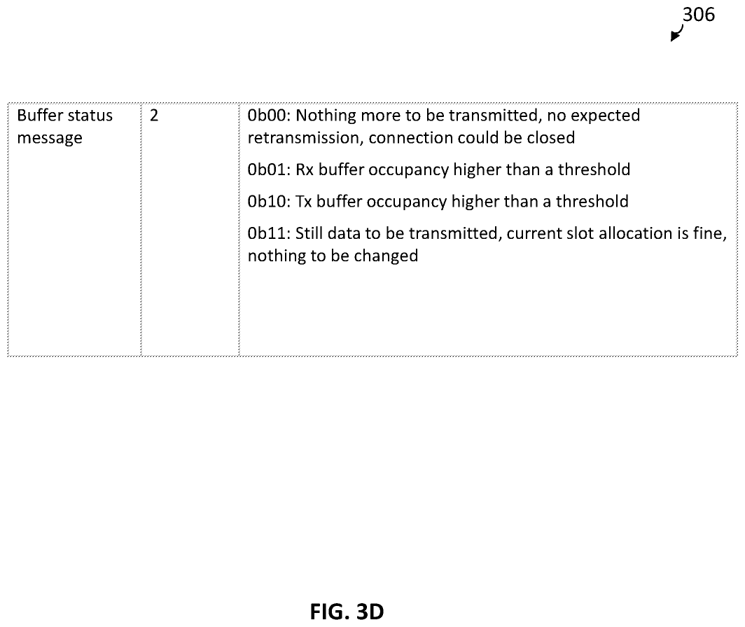

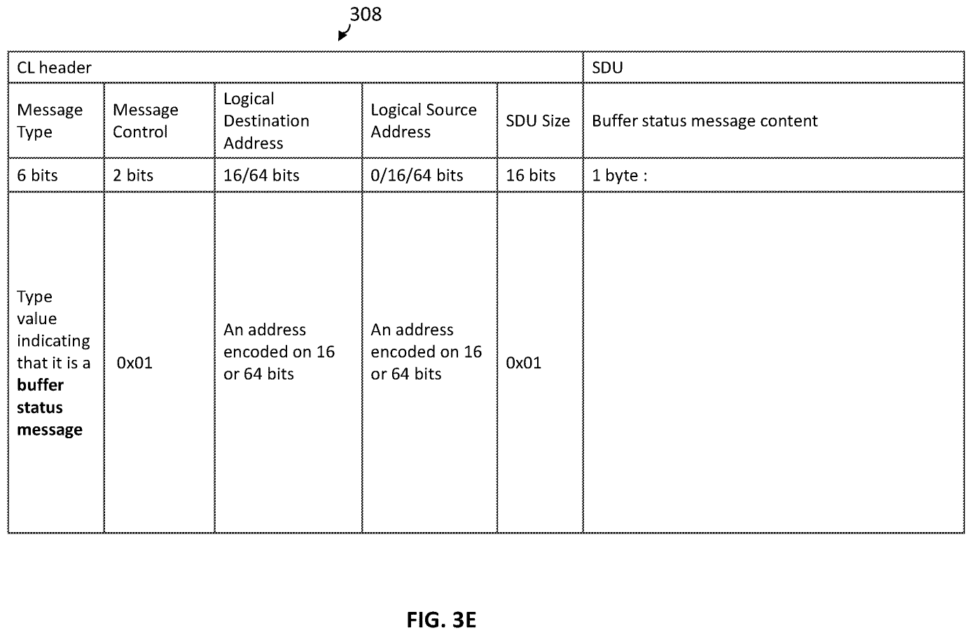

FIGS. 3A-3E illustrate various examples of LL packet header structures in a buffer status response message or a buffer status report message, according to some embodiments of the present disclosure. FIG. 3A illustrates a LL packet structure 300 of an exemplary LL control message in a CL mode, according to embodiments of the present disclosure. The LL control message may include a LL header (e.g., CL header) and SDU. The Message_Type field of the LL control message, typically containing 6 bits of data, may indicate the LL control message, e.g., a LL packet, is a buffer status message. The SDU field of the LL control message may indicate the buffer status of the UWB device (e.g., the controlee UWB device). As described above, the LL control message may be transmitted from a controlee UWB device to a controller UWB device, or vice versa.

The Message_Type field can be defined to distinguish the buffer status message from other LL control messages. In some embodiments, different types of a buffer status message are distinguished. For example, 0x00-0x7F can be used to indicate data message, and 0x80-0xFF can be used to indicate various LL control messages as below:
0x80-0x8F: control message to manage connection establishment
0x90-0x9F: control messages related to connection maintenance
0xA0-0xAF: control messages related to connection release
0xB0-0xBF: control message related to buffer status:
   0xB0: buffer status request
   0xB1: buffer status response
   0xB2: buffer status report

The SDU field of the LL control message may indicate the buffer status of the UWB device. For example, the message 0x0 indicates “Nothing more to be transmitted, no expected retransmission, connection could be closed.” The message 0x1 may indicate “Rx (receiver) buffer occupancy higher than a threshold (e.g., 50%).” In some embodiments, such indication of the Rx buffer may be used to indicate to the controller to decrease the rate of data transmission. The message 0x2 may indicate “Tx (transmitter) buffer occupancy higher than a threshold (e.g., 50%).” In some embodiments, such indication of the Tx buffer may be used to request from the controller more allocated slots to avoid buffer overflow. 0x3 may indicate “Still data to be transmitted, current slot allocation is fine, nothing to be changed.” The message 0x4-0xFF may indicate RFU (reserved for future use).

FIG. 3B illustrates another LL packet header structure 302 of an exemplary LL control message, according to some embodiments. LL packet header structure 302 may be a more generalized form of LL packet header structure 300. In some embodiments, instead of having source and destination addresses, LL packet header structure 302 may include a connection identifier to characterize the connection between the source and destination. In some embodiments, the UWB device (e.g., a controlee UWB device) that transmits the LL control messages in FIGS. 3A and 3B may include one buffer for receiving data and one buffer for transmitting data.

FIG. 3C illustrates another LL packet header structure 304 of an exemplary LL control message, according to some embodiments. In some embodiments, the UWB device (e.g., a controlee UWB device) that transmits the LL control message in FIG. 3C may include more than one buffer for receiving data and more than one buffer for transmitting data. Different from the LL control messages shown in FIGS. 3A and 3B, the SDU of the LL control message in FIG. 3C may indicate the buffer status of the more than one buffer for receiving data and more than one buffer for transmitting data in a bitmap. For example, the SDU may indicate the usages and occupancies of all buffers.

For example, referring back to the description of FIG. 1E, the UWB device may include a buffer for transmitting data for normal communication, a buffer for receiving data for normal communication, a buffer for transmitting data for secure communication, and a buffer for receiving data for secure communication. In some embodiments, as shown in FIG. 3C, the SDU of the LL control message indicates the buffer status for all buffers used for normal and secure connections.

FIG. 3D illustrates another LL packet header structure 306 of an exemplary LL control message, according to some embodiments. FIG. 3D shows an alternative way to indicate the buffer status by adding additional bits to the existing LL control messages. The additional bits may sufficiently indicate the buffer status, and no buffer status message content is needed in the SDU. For example, 2 bits of data can be added to the current Message_Type field of an existing LL control message (e.g., an ACK/NACK LL control message), to result in a 8-bit Message_Type field. The 2 bits may sufficiently indicate the buffer status of the UWB device, and no buffer status message content is needed in the LL control message.

In some embodiments, the buffer status message may be embedded in other existing control messages. For example, additional fields and/or additional bits can be added into the existing control messages to indicate the buffer status of a UWB device. In an example, a new field may be added in the existing command SET_APP_CONFIG_CMD. The command may provide the size of the data message to be transmitted. The field may be BUFFER_INDICATION_FIELD (or similar) to indicate the size of the data message to be transmitted.

FIG. 3E illustrates another LL packet header structure 308 of an exemplary LL control message, according to some embodiments. In some embodiments, the UWB device (e.g., a controller UWB device) may transmit the LL control message in FIG. 3E to another UWB device (e.g., a controlee UWB device) to request for buffer status report/response messages. The Message_type field may indicate the LL packet is a buffer status message or buffer request message, and the content may be blank. In an alternative embodiments, the content may include indication of the current slot allocation for the controlee UWB device, the size of data to be transmitted to the controlee UWB device, etc.

Referring back to FIG. 1B, as described, the UWB device (e.g., the controller UWB device) may adjust or maintain the slot allocation for data transmission of the other UWB device (e.g., the controlee UWB device), and/or terminate the connection with the other UWB device if both the controller and controlee UWB devices have no more data for transmission. The controller UWB may determine the operation and transmit the command for the operations in a data transfer control message (e.g., DTPCM) to the controlee UWB device. The controlee UWB device may transmit its data in the updated slots according to the command, or disconnect from the controller UWB device.

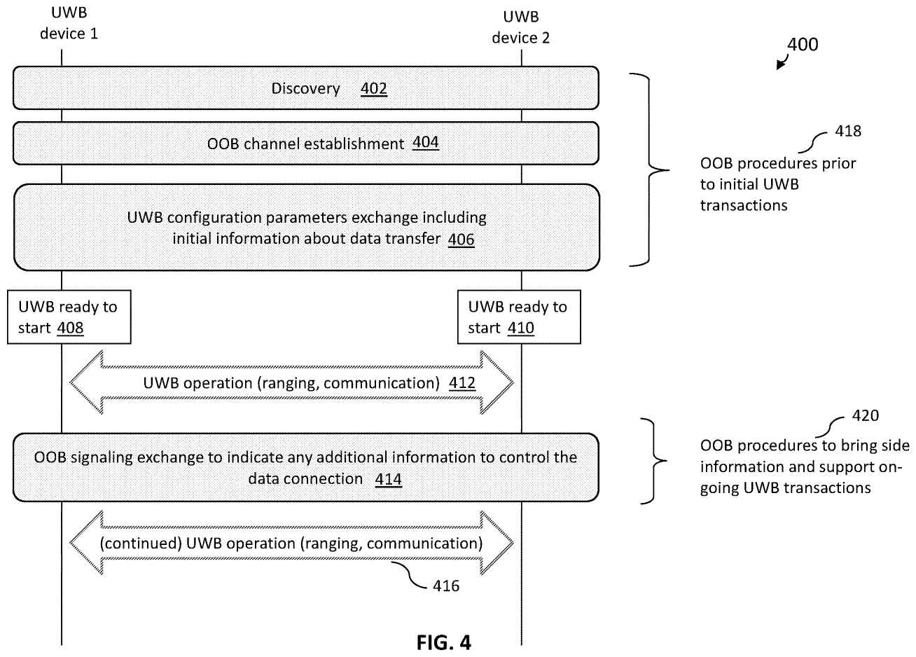

FIG. 4 illustrates a signaling diagram in which a controller UWB device and a controlee UWB device exchange the buffer status information using out-of-band (OOB) technology, according to some embodiments of the present disclosure. In some embodiments, the exchange of buffer status information is performed before the UWB connection/communication starts.

As shown in FIG. 4, UWB device 1 and UWB device 2 may represent a controller UWB device and a controlee UWB device, respectively. UWB device 1 and UWB device 2 may first discover their environment using a non-UWB technology (so called out-of-band (OOB) technology) in step 402. In some embodiments, Bluetooth Low Energy is considered for OOB. The two devices may then establish an OOB channel for communication in step 404. Using OOB communication channel, the two devices exchange the minimum set of parameters to operate the UWB function in step 406. For example, the two devices may exchange basic information about the UWB configuration such as channel to be used, parameters of UWB such as block, slot duration, PHY and MAC modes to be used, etc. In some embodiments, the UWB configuration information/parameters also include buffer status report message(s) as part of this OOB exchange. For example, the controlee UWB device and/or the controller UWB device may exchange, using the OOB technology, the foreseen size of data message to be transmitted in UWB communication. In some embodiments, operations performed in steps 402-406 are part of step 418, i.e., OOB procedure prior to initial UWB transactions.

During step 418, e.g., the discovery and/or parameters exchange, the two devices may also elect one of them to be the controller UWB device (e.g., UWB device 1), and the other one to be the controlee UWB device (e.g., UWB device 2). The controller UWB device can then use the parameters it received from the controlee to determine/update the slot allocation to the controlee UWB device, as described above.

UWB devices 1 and 2 may be conditioned to start UWB communications, in steps 408 and 410, respectively. The UWB operations (e.g., ranging, communication, etc.) may then start, in step 412. The UWB operations may include any suitable operations such as ranging, communication, etc. During the UWB operations, the controller UWB device can use the OOB channel and/or the UWB radio interface to request from the controlee additional inputs about the data communication status such as the size of new data to be transmitted or any more data to transmit, for the controller UWB device to control the data connection with the controlee UWB device. The controller UWB device may then update the slot allocation accordingly and/or terminate the session if no more data has to be transmitted. After the OOB signaling exchange is completed, the controller UWB device and the controlee UWB device may continue the UWB operations (e.g., ranging, communication, etc.) in step 416. In some embodiments, operation performed in step 414 is part of step 420, i.e., the OOB procedures to bring side information and support on-going UWB transactions.

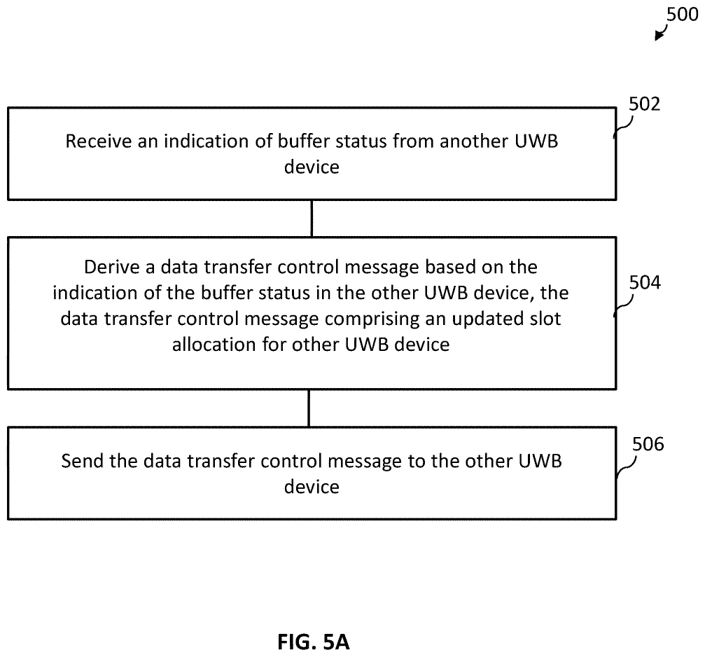

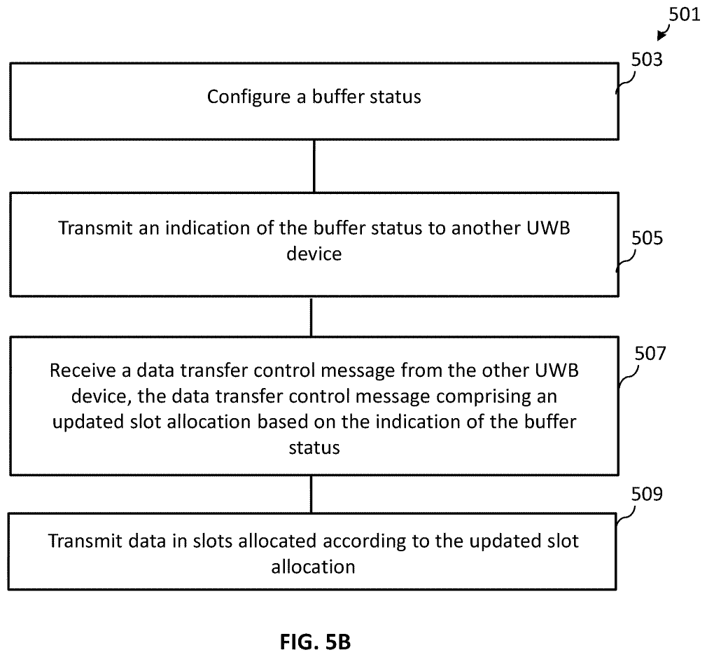

FIG. 5A is a flowchart of a method 500 for UWB device (e.g., a controller UWB device) to implement buffer control in a UWB system, according to some embodiments of the present disclosure. Method 500 is merely an example, and is not intended to limit the present disclosure beyond what is explicitly recited in the claims. Additional operations can be provided before, during, and after the method 500, and some operations described can be replaced, eliminated, or moved around for additional embodiments of method 500. For ease of illustration, FIG. 5A is described in connection with FIGS. 1B and 3A-3E.

At step 502, an indication of a buffer status from another UWB device is received. Referring back to FIG. 1B, controller UWB device 102a may receive a buffer status report message (or buffer status response message 134) from a controlee UWB device (e.g., controlee #1 UWB device 104-1). The buffer status report message (or buffer status response message 134) may include usage(s) of one or more buffers in the controlee UWB device, referring back to the description of FIGS. 3A-3D.

At step 504, a data transfer control message is derived based on the indication of the buffer status in the other UWB device, the data transfer control message including an updated slot allocation for the other UWB device. Referring back to FIG. 1B, controller UWB device 102a may derive a data transfer control message based on the indication of the usages of the buffer(s) in the controlee UWB device (e.g., controlee #1 UWB device 104-1). The data transfer control message, e.g., a data transfer phase control message (DTPCM), may include updated slot allocation and/or connection termination for the controlee UWB device and commands to allow the controlee UWB device to transmit data in the newly allocated slots. In some embodiments, the newly allocated slots may include slots for transmitting data to the controlee UWB device, and slots for the controlee UWB device to transmitting data. In some embodiments, the slots allocated for the controlee UWB device to receive data (e.g., from the controller UWB device 102a) is determined at least based on the buffer usage/occupancy of the controlee UWB device's receiver buffer (e.g., the number of data queues in the receiver buffer), and the slots allocated for the controlee UWB device to transmit data is determined at least based on the buffer usage/occupancy of the controlee UWB device's transmitter buffer (e.g., the number of data queues in the transmitter buffer).

At step 506, the data transfer control message is sent to the other UWB device. Referring back to FIG. 1B, controller UWB device 102a may transfer the data transfer control message to the controlee UWB device (e.g., controlee #1 UWB device 104-1) such that the controlee UWB device may follow the commands in the data transfer control message accordingly. In some embodiments, controller UWB device 102a may transmit data in the newly allocated slots to the controlee UWB device.

FIG. 5B is a flowchart of a method 501 for a UWB device (e.g., a controlee UWB device) to implement buffer control in a UWB system, according to some embodiments of the present disclosure. Method 501 is merely an example, and is not intended to limit the present disclosure beyond what is explicitly recited in the claims. Additional operations can be provided before, during, and after the method 501, and some operations described can be replaced, eliminated, or moved around for additional embodiments of method 501. For ease of illustration, FIG. 5B is described in connection with FIGS. 1B, 1C, 1E, 2A, and 3A-3E.

At step 503, a buffer status is configured. Referring back to FIG. 1C, a controlee UWB device may configure its buffer status (e.g., usage, occupancies, etc.) through UCI (e.g., UCI 105 or 135), e.g., from the upper layers (e.g., upper layers 103 or 133). The buffer status may be constructed into a LL control message, referring back to the description of FIGS. 3A-3E.

At step 505, an indication of the buffer status is transmitted to another UWB device. Referring back to FIGS. 1B and 3A-3E, the controlee UWB device (e.g., controlee #1 UWB device 104-1) may transmit a buffer status report message (or buffer status response message 134) to controller UWB device 102a. The buffer status report message (or buffer status response message) may include indication of buffer status in the controlee UWB device.

At step 507, a data transfer control message is received from the other UWB device, the data transfer control message including an updated slot allocation for based on the indication of the buffer status. Referring back to FIG. 1B, a controlee UWB device (e.g., controlee #1 UWB device 104-1) may receive a data transfer control message, e.g., DTPCM 136, from controller UWB device 102a. The data transfer control message includes an updated slot allocation for the controlee UWB device and/or connection termination with the controlee UWB device.

At step 509, data is transmitted in the slots allocated according to the updated slot allocation. Referring back to FIG. 1B, the controlee UWB device (e.g., controlee #1 UWB device 104-1) may transmit data in the slots allocated by the data transfer control message.

Those skilled in the art will recognize improvements and modifications to the preferred embodiments of the present disclosure. All such improvements and modifications are considered within the scope of the concepts disclosed herein and the claims that follow.

1. A method for buffer control in ultra-wideband (UWB) communication in a UWB device, comprising:
receiving an indication of a buffer status from another UWB device;
deriving a data transfer control message based on the indication of the buffer status in the other UWB device, the data transfer control message comprising an updated slot allocation for the other UWB device; and
sending the data transfer control message to the other UWB device.

2. The method of claim 1, wherein:
the indication of the buffer status comprises a buffer status report that is part of a link-layer control packet sent by the other UWB device;
the indication of the buffer status is part of a message send by the UWB system of one UWB device to the other UWB device; and
the indication of the buffer status is sent by the upper layer of the UWB device to the upper layers of the other UWB device.

3. The method of claim 2, further comprising sending a buffer status request to the other UWB device prior to receiving the buffer status report, the buffer status request comprising a command requesting for the buffer status in the other UWB device,
wherein the buffer status report comprises a buffer status response by the UWB device replying to the buffer status request.

4. The method of claim 2, wherein:
the buffer status report comprises an indication of buffer status of a receiver buffer and a transmitter buffer in the other UWB device; and
the data transfer control message comprises at least one of slot allocations for the receiver buffer and the transmitter buffer, or a request for connection termination.

5. The method of claim 2, wherein:
the buffer status report comprises an indication of buffer status of at least a receiver buffer and a transmitter buffer for a normal connection, or a receiver buffer and a transmitter buffer for a secure connection; and
the data transfer control message comprises slot allocations for the receiver buffer and the transmitter buffer for the normal connection, or the receiver buffer and the transmitter buffer for the secure connection.

6. The method of claim 2, wherein the link-layer control packet is a dedicated buffer control message, and comprises a header field with all bits indicating a message type of the buffer status report, and a service data unit (SDU) indicating a content of the buffer status report.

7. The method of claim 2, wherein the link-layer control packet is an ACK/NACK control message, and comprises a header field with a portion of the bits indicating a message type of the ACK/NACK control message and additional bits indicating the buffer status.

8. The method of claim 3, wherein:
the buffer status request is part of a link-layer control packet, and
the link-layer control packet comprises a header field with all bits indicating a message type of the buffer status request, and a service data unit (SDU) indicating a content of the buffer status request.

9. The method of claim 1, wherein the data transfer control message comprising a command for connection termination to the other UWB device.

10. The method of claim 1, wherein the indication of a usage of a buffer comprises a set of configuration parameters transmitted by the other UWB device through a non-UWB channel, the set of configuration parameters reflecting the buffer status in the other UWB device.

11. The method of claim 10, wherein the non-UWB channel comprises a Bluetooth Low Energy channel.

12. The method of claim 1, further comprising, sending user data to the other UWB device based on the updated slot allocation.

13. An ultra-wideband (UWB) device, comprising
a transceiver operable to perform a UWB communication;
a memory for storing program instructions and a buffer status of another UWB device; and
a processor coupled to the transceiver and to the memory, wherein the processor is operable to execute the program instructions, which, when executed by the processor, cause the UWB device to perform the following to facilitate slot allocation to support data communication with the other UWB device:
receiving an indication of a buffer status from the other UWB device;
deriving a data transfer control message based on the indication of the buffer status in the other UWB device, the data transfer control message comprising an updated slot allocation for the other UWB device; and
sending the data transfer control message to the other UWB device.

14. The UWB device of claim 13, wherein the indication of the buffer status comprises a buffer status report that is part of a link-layer control packet sent by the other UWB device.

15. The UWB device of claim 14, further comprising sending a buffer status request to the other UWB device prior to receiving the buffer status report, the buffer status request comprising a command requesting for the buffer status in the other UWB device,
wherein the buffer status report comprises a buffer status response by the UWB device replying to the buffer status request.

16. The UWB device of claim 14, wherein:
the buffer status report comprises an indication of buffer status of a receiver buffer and a transmitter buffer in the other UWB device; and
the data transfer control message comprises a command for slot allocations for the receiver buffer and the transmitter buffer.

17. The UWB device of claim 14, wherein the link-layer control packet comprises a header field indicating a message type of the buffer status report, and a service data unit (SDU) indicating a content of the buffer status report.

18. The UWB device of claim 15, wherein:
the buffer status request is part of a link-layer control packet, and
the link-layer control packet comprises a header field indicating a message type of the buffer status request, and a service data unit (SDU) indicating a content of the buffer status request.

19. A method for buffer control in ultra-wideband (UWB) communication in a UWB device, comprising:
configuring a buffer status;
transmitting an indication of the buffer status to another UWB device;
receiving a data transfer control message from the other UWB device, the data transfer control message comprising an updated slot allocation for the buffer based on the indication of the buffer status; and
transmitting data in slots allocated according to the updated slot allocation.

20. The method of claim 19, wherein the indication of the buffer status comprises at least one of:
a buffer status report that is part of a link-layer control packet, or
a set of configuration parameters transmitted through a non-UWB channel, the set of configuration parameters reflecting the buffer status in the other UWB device.
